(19) United States
(12) Patent Application Publication
(10) Pub. No.: US 2006/0154220 A1
(43) Pub. Date: Jul. 13, 2006

(54) Dance training device

(76) Inventor: Mary Toniolo, Victoria (AU)

Correspondence Address: DENNISON, SCHULTZ, DOUGHERTY & MACDONALD, 1727 KING STREET, SUITE 105, ALEXANDRIA, VA, 22314, US

(21) Appl. No.: 10/519,842

(22) PCT Filed: Jul. 11, 2003
(86) PCT No.: PCT/AU03/00907

§ 371 Date: Jan. 12, 2005

(30) Foreign Application Priority Data
Jul. 12, 2002 (AU) 2002950177
Jan. 8, 2003 (JP) 2003900170

(51) Int. Cl. G09B 19/00

(52) U.S. Cl. 434/250

(57) ABSTRACT

A training device for a dancer comprising a mat (1) or the like wherein said mat is provided with a set of indicia representing the preferred position for the dancer during any one or a combination of movements pertaining to said dance. An electronic system for training a dancer comprising the above and a video capture means (54) for capturing a live image of the dancer as the dancer performs a dance routine and means for generating text and/or graphical images (52) for display to the dancer in conjunction with the live image and display means for displaying the live image combined with the text and/or graphical images (56) to the dancer to perform the dance routine.

### FIELD OF THE INVENTION

The present invention relates generally to training devices to teach individuals, especially novices, proper foot position and body movement during dance. More particularly, the present invention relates to training devices for teaching ballet. The training device of the present invention particularly allows the individual to determine the correct position of his or her feet in relation to a ballet bar. The present invention further allows a visually impaired individual to determine the correct position of his or her feet in relation to a ballet bar.

The invention also relates to an electronic system for training individuals, particularly dancers.

### BACKGROUND OF INVENTION

The origins of Ballet can be traced back to the 1581 performance of the Ballet Comique de la Royne at the Palais du Petit Bourbon in Paris. Ballet has since developed into a highly structured form of dance that requires years of practice to perfect. Ballet is a fascinating and enjoyable art form and there are many different forms of ballet including classical, jazz and modern. There are also large numbers of dance companies throughout the world.

Individuals are often introduced to ballet at a very young age; that is as early as two to three years old. As such, individuals wishing to learn ballet spend years practicing and a great deal of energy is devoted to developing the proper form and the right body position associated with ballet. The earlier children develop correct habits relating to foot positions the easier they find it to adopt the correct dance positions. Once the wrong positions are learnt and are not corrected early, students find it very difficult to adopt the correct stance and often lose interest. Ballet requires hours of practice and it is desirable to make the experience as enjoyable to the novice dancer as possible.

Many individuals, especially novices, attend ballet classes where ballet teachers instruct the students regarding the basic steps. During classes, ballet teachers instruct individuals in the correct foot positions often by demonstrating the movements. Individuals often find it difficult to remember the direction their fee should point during classes. This problem is particularly prevalent in very young individuals who may not even know which is their left and which is their right foot.

Another difficulty which individuals encounter is that they have problems remembering the position and order of foot movement once outside ballet class and without dedicated tuition. Younger individuals are particularly disadvantaged in this respect as they are not able to reproduce the movements learnt in the class and therefore cannot practice. This often leads to frustration at their lack of progress and they can quickly lose interest.

In order to address such problems, individuals have heretofore been trained with reference to training books and taught by showing the contents of such books. Dance training books often show illustrations of foot position of dancers. Such illustrations include multiple foot positions, arrows for the direction of foot movement, and figures that are all shown in an intricate fashion on a single page. However, given ballet is often taught to children as young as two years old, this method of training has proved ineffectual. Younger individuals find it difficult to continuously maintain the level of concentration needed to utilize the prior art dance guidebooks, and will soon give up and not master and enjoy dance. For this reason, prior art dance guidebooks are not always suitable for teaching students.

Learning the basic steps is fundamental to mastering the more complicated routines as the participant skill level progresses. The basic steps in ballet can be distilled into five fundamental foot positions. A plurality of these basic steps is combined to perform simple routines. Depending on the skill level of the dancer, these routines can be choreographed together to perform set pieces. There are currently no effective training aids which teach the fundamental foot positions.

Consequently, a need still exists for a different approach to design a training aid for individuals learning the basic steps for ballet.

At present there is no system in place to enable a dancer to record their dance movements and overlay such recording with text or graphical images assisting the dancer to perform the various dance routine or movements. At present the dancer, when not receiving tuition, has to resort to his or her memory or books to practice the dance steps or routines in their own spare time. As mentioned previously, particularly where the dancers or individuals are relatively young, this is not the most ideal and practical learning method.

The present invention also provides a facility that allows real time video capture, and optionally a recordal thereof which displays a live image of the dancer as they are performing a dance routine. It also provides a musical or audio input together with text and graphical overlays on the video image to assist the individual in performing the particular dance. A permanent recording may be taken of the live image capture for the individual to use at home or in their own spare time in order to practice the dance movements or dance routines.

### SUMMARY OF THE INVENTION

In a first aspect of the invention provides a training device for a dancer comprising a mat or the like wherein said mat is provided with a set of indicia representing the preferred position for the dancer during any one or a combination of movements pertaining to said dance.

The indicia may represent the position of the feet and or the toe region of said dancer and preferably represents a sequential combination of movements pertaining to said dance.

The indicia may represent a sequential and progressive series of movements pertaining to said dance.

The indicia may represent a sequential and reversible series of movements pertaining to said dance.

Further indicia may be positioned to indicate the preferred foot position for individuals with short legs, especially children.

The invention may comprise a combination of mats adapted to provide indicia to represent both progressive and reversible movements.

The indicia may be selected from any one or more a combination of tactile, visual, color-coded or other sensory devices.

The indicia may be foot shaped including left and right whole feet and toe indicia.

The device of the invention may also include a balancing device including horizontal or vertical bars adapted for positioning at or near said mat or mats to assist the user in balancing during the performance of said dance movements.

The invention may provide a plurality of mats adapted for co-engagement together or in an array by way of protruding lugs or other engaging means known to those skilled in the relevant art. The mats may include engagement means for one or a plurality of balancing bars.

The balancing bars may be adjustable vertically and or horizontally.

According to a further aspect of the invention there is provided an electronic system for training a dancer, comprising:

video capture means for capturing a live image of the dancer as the dancer performs a dance routine;

means for generating text and/or graphical images for display to the dancer in conjunction with the live image;

display means for displaying the live image combined with the text and/or graphical images to the dancer to aid the dancer to perform the dance routine; and

wherein said dancer has a mat provided with a set of indicia representing preferred positions for the dancer during a dance routine.

The system may include video buffer means for combining the live image of the dancer with the text and/or graphical images as a combined signal for output to a video encoder means. The display means may be a television terminal linked to an output of the video encoder so as to receive the combined signal.

The system may include cartridge means, in the form of a music cartridge for electronically storing music preferably in the form of songs. Preferably a memory module on the cartridge means stores the music or audio together with the digital form of the text and/or graphical images. The cartridge means may be linked to an audio generator for generating the audio corresponding to the stored music to be either broadcast with the combined signal or broadcast alone.

A remote control unit, operable by the individual dancer may be used to control the playing of the music in the cartridge means and also to control the operation of the video capture means, which is preferably an image sensor or video camera. The remote control unit may be housed in balancing bars used by the dancer to assist in providing support or balance as the dancer performs the dance routine.

Preferably a processing means in the form of a micro-controller controls the audio generator, reads and writes to the cartridge means, controls the video buffer means and video encoder means as well as the video capture means. The micro-controller may also be linked to an infrared detector or remote control sensor for receiving infrared signals from the remote control unit. The means for generating-text and/or graphical images may be produced by an on screen display generator which conveniently may be housed in the same unit as the micro-controller.

The live image and/or overlayed text and/or graphical images may be recorded by a video cassette recorder or other recording means linked to the television terminal.

According to yet another aspect of the invention there is provided an electronic method for training a dancer comprising the steps of:

capturing a live image of the dancer as the dancer performs a dance routine;

generating text and/or graphical images;

overlaying or combining the generated text and/or graphical images with the live image; and

displaying the dancer the combined live image and text and/or graphical images to aid the dancer to perform the dance routine.

### BRIEF DESCRIPTION OF THE ACCOMPANYING FIGURES

For a further understanding of the nature and object of the invention, reference should be had to the detailed description of the exemplary embodiments which taken in conjunction with the appended drawings.

FIG. 1 shows a top view of one embodiment of the training device of the present invention as a single mat with foot indicia indicating the movement of the left foot;

FIG. 1a shows a top view of an alternative embodiment of the training device of the present invention as a single mat with foot indicia indicating the movement of the right foot;

FIG. 2 shows a top view of an alternative embodiment of the training device of the present invention as a single mat;

FIG. 3 shows the invention as a combination of two engaged mats with a balancing bar between and positional indicia showing the movement of the left foot;

FIG. 3a shows an alternative embodiment of the present invention as a combination of two engaged mats with balancing bar between and positional indicia showing the movement of the right foot;

FIG. 4 shows a side view of the training device of the present invention;

FIG. 5 shows a front view of the training device of the present invention;

FIG. 6 shows a perspective view of the training device of the present invention;

FIG. 7 shows a top view of an alternative embodiment of the training device of the present invention with positional indicia showing the movement of the left foot;

FIG. 7a shows a top view of an alternative embodiment of the training device of the present invention with positional indicia showing the movement of the right foot;

FIG. 8 shows a top view of an alternative embodiment of the training device of the present invention;

FIG. 9 shows a perspective view of an individual using the training device of FIG. 3;

FIG. 10 shows a side view of the training device of FIG. 3;

FIG. 11 shows a front view of one embodiment of the adjustable ballet bar of the present invention;

FIG. 12 shows a front on view of an alternative embodiment of the adjustable ballet bar of the present invention;

FIG. 13 is a block diagram showing the system components used to train a dancer according to a further aspect of the invention; and

FIG. 14 is a perspective view showing a portion of the balancing bars used by a dancer having housed therein a remote control unit in order to control various aspects of the system in FIG. 13.

### PREFERRED EMBODIMENTS OF THE PRESENT INVENTION

The invention will now be described with reference to particular embodiments and examples that are not limiting to the scope of the invention. The drawings show elements of the present invention, which are merely representative of the preferred embodiment inasmuch as the preferred embodiment employs colored elements which are not possible to show in the drawings.

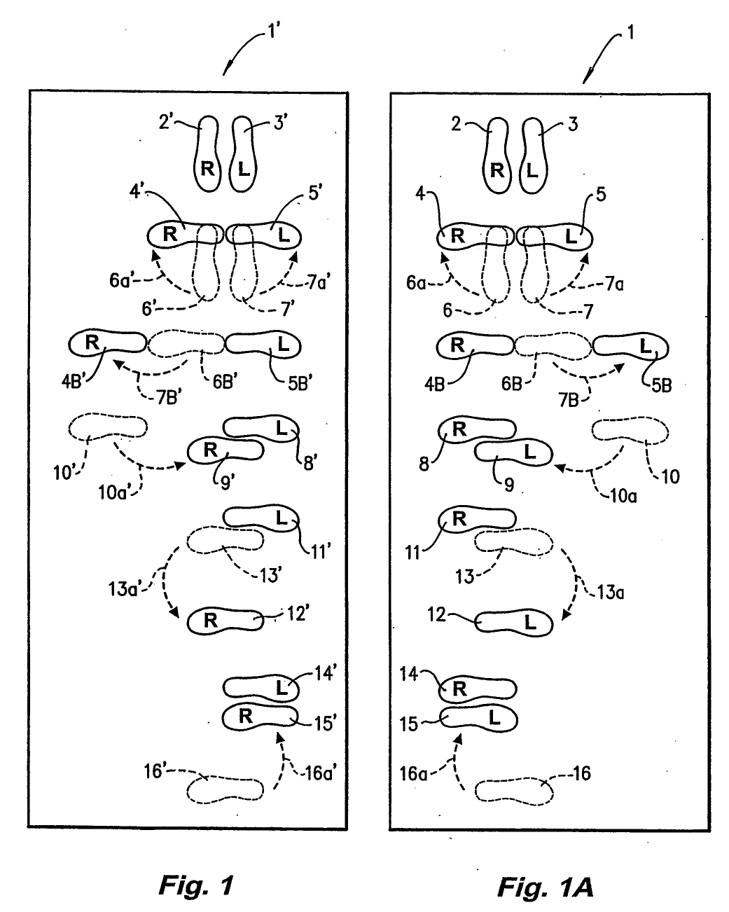

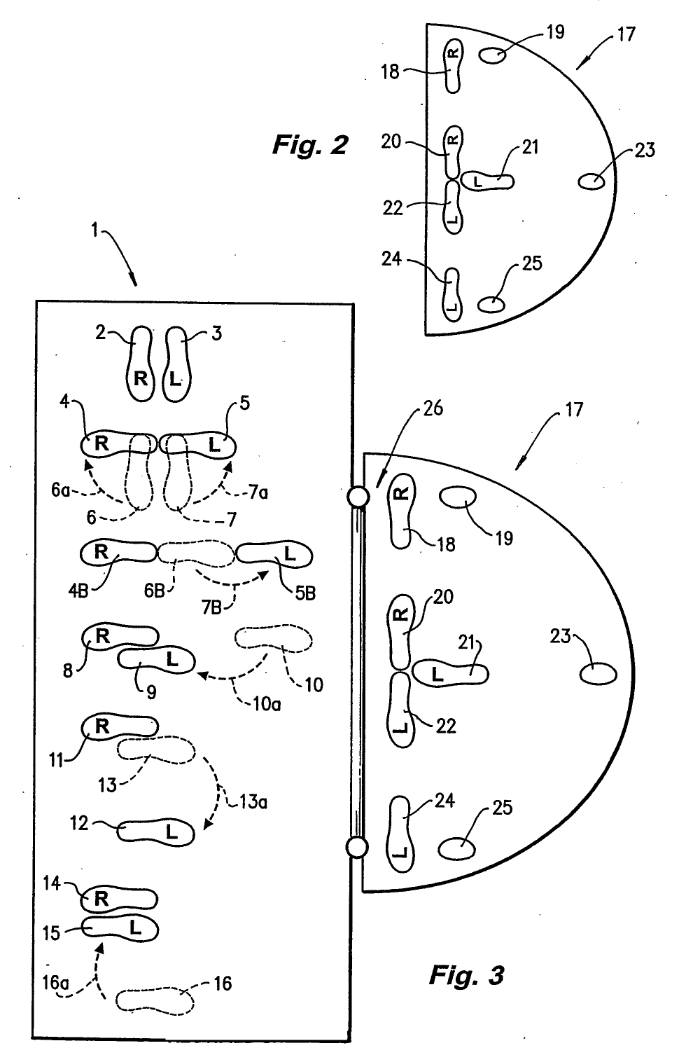

Referring now to the drawings of the training device of the present invention, and particularly to FIGS. 1, 1a and 2, there are illustrated two training mats 1 and 17 which are adapted for ballet.

Referring firstly to FIG. 1, training mat 1 is a rectangular shaped mat that is particularly suited to progressive step training, particularly in relation to teaching where a dancer moves their left foot. Alternatively, the training mat 1 may be of any geometric shape. Preferably, the training mat has at least one substantially straight edge. The training mat can be provided with a balancing ballet bar 26 or 33 as illustrated in FIGS. 11 and 12 respectively that can be fitted to the mat. The bar can be interlocking with the mat or can be separate from the mat, but placed in a close juxtaposition to allow the dancer to balance. It is preferred that the bar is placed in close proximity to the dancer to assist the dancer to balance when performing the dance movements.

Referring now to FIG. 1a, training mat 1′ is a rectangular shaped mat that is particularly suited to progressive step training, particularly in relation to teaching where a dancer moves their right foot. Alternatively, the training mat 1′ may be of any geometric shape. Preferably, the training mat has at least one substantially straight edge. The training mat can be provided with a balancing ballet bar 26 or 33 that can be fitted to the mat. The bar can be interlocking with the mat or can be separate from the mat, but placed in a close juxtaposition to allow the dancer to balance. Again, it is preferred that the bar is placed in close proximity to the dancer to assist the dancer to balance when performing the dance movements. Training mat 1′ may be printed on the back of training mat 1.

Referring now to FIG. 2, an alternative shape of mat 17 is a semi-circular shaped mat that is particularly suited to repetition and reversible steps. Alternatively; the training mat 17 may be of any geometric shape. Preferably, the training mat has at least one substantially straight edge. The training mat can also be provided with a balancing ballet bar 26 or 33 that can be fitted to the mat. The bar can be interlocking with the mat or alternatively can be separate from the mat, but placed in close juxtaposition to assist the dancer to balance.

Both training mats 1, 1′ and 17 are preferably made from pliable materials such as synthetic polymers, natural fabrics, and others known to those skilled in the art, which may be rolled into a compact package for storage.

Alternatively, training mat 1, 1′ and 17 can be made from a rigid material such as plastics, woods, laminates, and others known to those skilled in the art. Whether a pliable or rigid material is selected for producing training mat 1, 1′ and 17, generally, a thickness is chosen which allows users to stand on the mat without movement thereof, and to withstand wear and tear.

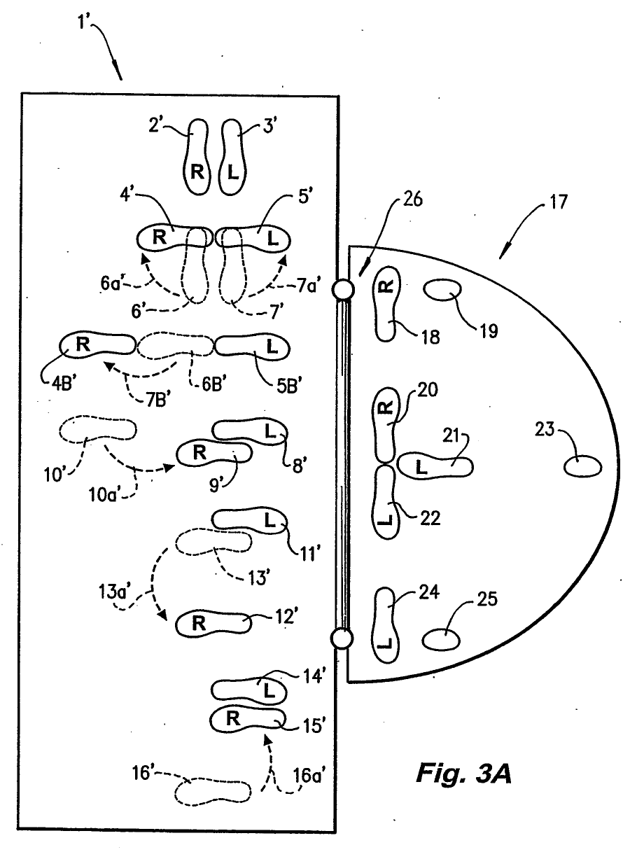

Referring now to FIG. 3, the training mats 1, 17 are attached along one leading edge, and a balancing ballet bar 26 is placed in a position between the said mats. Preferably said bar is attached to the mats and is able to support dancer during the performance of dance routines. The positioning of said bar is beneficial as it assists the dancer to maintain the correct body position while performing dance routines.

Training mats 1 and 17 as illustrated in FIG. 3 are attached along one leading edge. The mats can be interlocking by a temporary attachment means such as a zipper, hook and loop fastener, buttons or others known to those skilled in the art. An alternative embodiment comprises the mats being permanently affixed to each other. In yet another embodiment, the training mats are placed in close juxtaposition without been attached along one leading edge.

Positional indicia are affixed to training mat 1 comprising a series of foot positions 2 to 16, 4B, 5B and 6B. Further positional indicia are affixed to training mat 17 comprising a series of foot position 18, 20 to 22 and toe indicia 19, 23 and 25 and 24 to 25.

The positional indicia 2 to 16, 4B, 5B and 6B and 18 to 25 may be affixed to said training mats by a painting process; a silk-screening process or other commonly used coating process known to those skilled in the art. Alternatively, the positional indicia may be affixed to give a tactile sensation to the individual, especially visually impaired individuals. The tactile indicia may be temporally attached to training mat 1and 17. Alternatively, the tactile indicia may be permanently attached to training mat 1 and 17.

Positional indicia 2, 4, 4B, 6, 8, 11, 14, 18, 23 and 25 are preferably attached to training mat 1 and 17 as a red colour, while positional indicia 3, 5, 5B, 7, 6B, 9, 10, 13, 12, 15, 16, 19, 21, 22 and 24 are preferably attached to training mat 1 and 17 as a blue colour. Alternatively, positional indicia 2, 4, 4B, 6, 8, 11, 14, 18, 23 and 25 are attached to said mat as any color, while positional indicia 3, 5, 5B, 7, 6B, 9, 10, 13, 12, 15, 16, 19, 21, 22 and 24 are preferably attached to said mat as any other color.

As shown in FIG. 1, positional indicia 2, 4, 4B, 6, 8, 11, 14 and 18 indicate where a dancer places their right foot. Positional indicia 23 and 25 indicate where a dancer places their right toe. Positional indicia 3, 5, 5B, 7, 6B, 9, 10, 13, 12, 15, 16, 22, 21 and 24 indicate where a dancer places his or her left foot. Positional indicia 19 instructs where a dancer places their left toe.

Referring now to training mat 1 that helps teach a dancer where to move their left foot. A dancer places their right foot on positional indicia 6 and their left foot on positional indicia 7. The individual then moves their right foot from positional indicia 6 along arrow 6a to positional indicia 4. The individual then moves their left foot from positional indicia 7, along arrow 7a to positional indicia 5. Alternatively, the movement of both feet can be performed simultaneously. It is preferable that individuals using the foot indicia of the present invention balance: themselves by holding the ballet bar device 26 or 33. The use of the ballet bar device is encouraged as it allows the individual, especially a novice, to more easily control the movement of their feet and results in a more reproducible body movement.

Further, an individual can place their right foot on positional indicia 4B and their left foot on positional indicia 6B and move their left foot along arrow 7B to positional indicia 5B.

Further, an individual can place their right foot on positional indicia 8 and their left foot on positional indicia 10 and move their left foot along arrow 10a to positional indicia 9.

Further, an individual can place their right foot on positional indicia 11 and their left foot on positional indicia 12 and move their left foot along arrow 13a to positional indicia 13.

Further, an individual can place their right foot on positional indicia 14 and their left foot on positional indicia 16 and move their left foot along arrow 16a to positional indicia 15.

Further, an individual can place their right foot on positional indicia 18 and their left tow on positional indicia 19.

Further, an individual can place their right leg on positional indicia 20 and their left leg on positional indicia 22.

Further, an individual can place their left leg on positional indicia 21 and their right tow on positional indicia 23.

Further, an individual can place their left foot on positional indicia 24 and their right tow on positional indicia 25.

Referring now to FIG. 3a, the training mats 1′ and 17 are attached along one leading edge, and a balancing ballet bar 26 is placed in a position between the mats. Preferably said bar is attached to the mats and is able to support dancer during the performance of dance routines. The positioning of the bar is beneficial as it allows the dancer to maintain the correct body position while performing dance routines.

Training mats 1′ and 17 as illustrated in FIG. 3a are attached along one leading edge. The mats can be interlocking and the attachment can be temporary such as a zipper, hook and loop fastener, buttons or others known to those skilled in the art. An alternative embodiment comprises the mats being permanently affixed to each other. In yet another embodiment, the training mats are placed in close juxtaposition without been attached along one leading edge.

Positional indicia are affixed to training mat 1′ comprising a series of foot positions 2′ to 16′, 4B′, 5B′ and 6B′. Further positional indicia are affixed to training mat 17 comprising a series of foot position 18, 20 to 22 and toe indicia 19, 23 and 25 and 24 to 25.

The positional indicia 2′ to 16′, 4B′, 5B′ and 6B′ and 18 to 25 may be affixed to the training mats by a painting process; a silk-screening process or other commonly used coating process known to those skilled in the art. Alternatively, the positional indicia may be affixed to give a tactile sensation to the individual, especially visually impaired individuals. The tactile indicia may be temporally attached to training mat 1′ and 17. Alternatively, the tactile indicia may be permanently attached to training mat 1′ and 17.

Positional indicia 2′, 4′, 4B′, 6′, 6B′, 9′, 10′, 12′, 13′, 15′, 16′, 23 and 25 are preferably attached to training mat 1′ and 17 as a red colour, while positional indicia 3′, 5′, 5B′, 7′, 8′, 11′, 14′, 19, 21, 22 and 24 are preferably attached to training mat 1′ and 17 as a blue colour. Alternatively, positional indicia 2′, 4′, 4B′, 6′, 6B′, 9′, 10′, 12′, 13′, 15′, 16′, 23 and 25 are attached to the mat as any color, while positional indicia 3′, 5′, 7′, 8′, 11′, 14′, 19, 21, 22 and 24 are preferably attached to the mat as any other color.

As shown in FIG. 1, positional indicia 2′, 4′, 4B′, 6′, 6B′, 9′, 10′, 12′, 13′, 15′, 16′ and 18 and 20 indicate where a dancer places their right foot. Positional indicia 23 and 25 indicate where a dancer places their right toe. Positional indicia 3′, 5′, 5B′, 7′, 8′, 11′, 14′, 21, 22 and 24 indicate where a dancer places his or her left foot. Positional indicia 19 instructs where a dancer places their left toe.

Referring now to training mat 1′ that helps teach a dancer where to move their left foot. A dancer places their right foot on positional indicia 6′ and their left foot on positional indicia 7′. The individual then moves their right foot from positional indicia 6′ along arrow 6a′ to positional indicia 4′. The individual then moves their left foot from positional indicia 7′, along arrow 7a′ to positional indicia 5′. Alternatively, the movement of both feet can be performed simultaneously. It is preferable that individuals using the foot indicia of the present invention balance themselves by holding the ballet bar device 26 or 33. The use of the ballet bar device is encouraged as it allows the individual, especially a novice, to more easily control the movement of their feet and results in a more reproducible body movement.

Further, an individual can place their right foot on positional indicia 6B′ and their left foot on positional indicia 5B′ and move their right foot along arrow 7B′ to positional indicia 4B′.

Further, an individual can place their right foot on positional indicia 10′ and their left foot on positional indicia 8′ and move their right foot along arrow 10a′ to positional indicia 9′.

Further, an individual can place their right foot on positional indicia 13′ and their left foot on positional indicia 11′ and move their right foot along arrow 13a′ to positional indicia 13′.

Further, an individual can place their right foot on positional indicia 16′ and their left foot on positional indicia 14′ and move their right foot along arrow 16a′ to positional indicia 15′.

Further, an individual can place their right foot on positional indicia 18 and their left tow on positional indicia 19.

Further, an individual can place their right leg on positional indicia 20 and their left leg on positional indicia 22.

Further, an individual can place their left leg on positional indicia 21 and their right tow on positional indicia 23.

Further, an individual can place their left foot on positional indicia 24 and their right tow on positional indicia 25.

It is advantageous to repeat the above movements using the described foot movements in order to improve the individual's technique. By following the foot positional indicia as described above, the individual can quickly learn the basic steps of ballet.

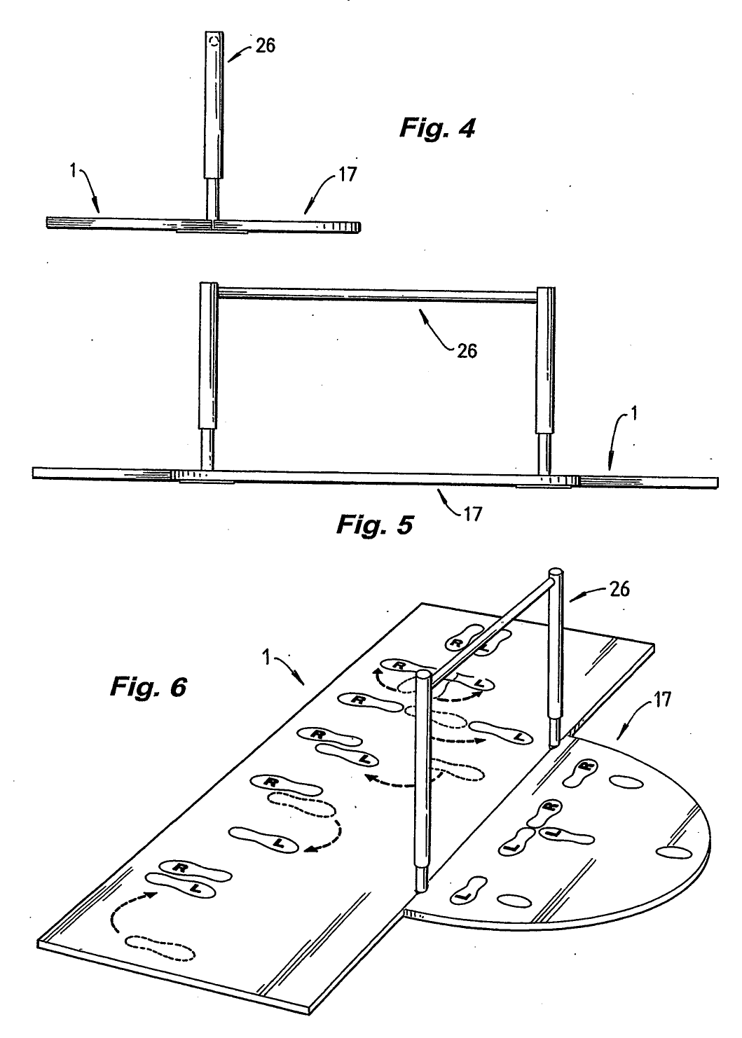

Referring now to FIG. 4, the training device of the present invention is shown side-on, with training mat 1, 17 and ballet balancing bar 26 positioned in the middle. Alternatively, the ballet balancing bar 26 can be positioned substantially in the middle.

Referring now to FIG. 5, the training device of the present invention is shown front on with training mat 1, 17 and ballet balancing bar 26 positioned between said mats. Alternatively, the ballet balancing bar 26 can be positioned substantially in the middle.

Referring now to FIG. 6, the training device of the present invention is shown in perspective with the training mat 1, 17 and ballet balancing bar 26 positioned between the mats.

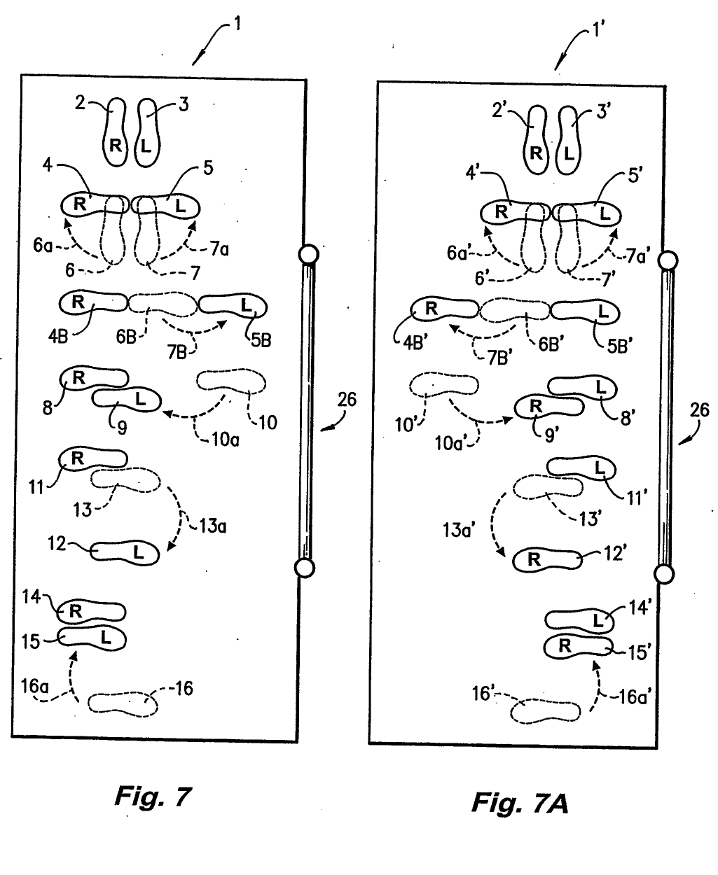

Referring now to FIG. 7, the training device of the present invention can be used with training mat 1 and ballet bar device 26 alone. Alternatively, training mat 1 can be used in conjunction with ballet bar 33. In still another embodiment of the present invention, training mat 1 can be used in conjunction with a wall mounted ballet bar device.

Referring now to FIG. 7a, an alternative embodiment of the training device of the present invention whereby training mat 1′ and ballet bar device 26 are shown alone. Alternatively, training mat 1′ can be used in conjunction with ballet bar 33. Instill another embodiment of the present invention, training mat 1′ can be used in conjunction with a wall mounted ballet bar device.

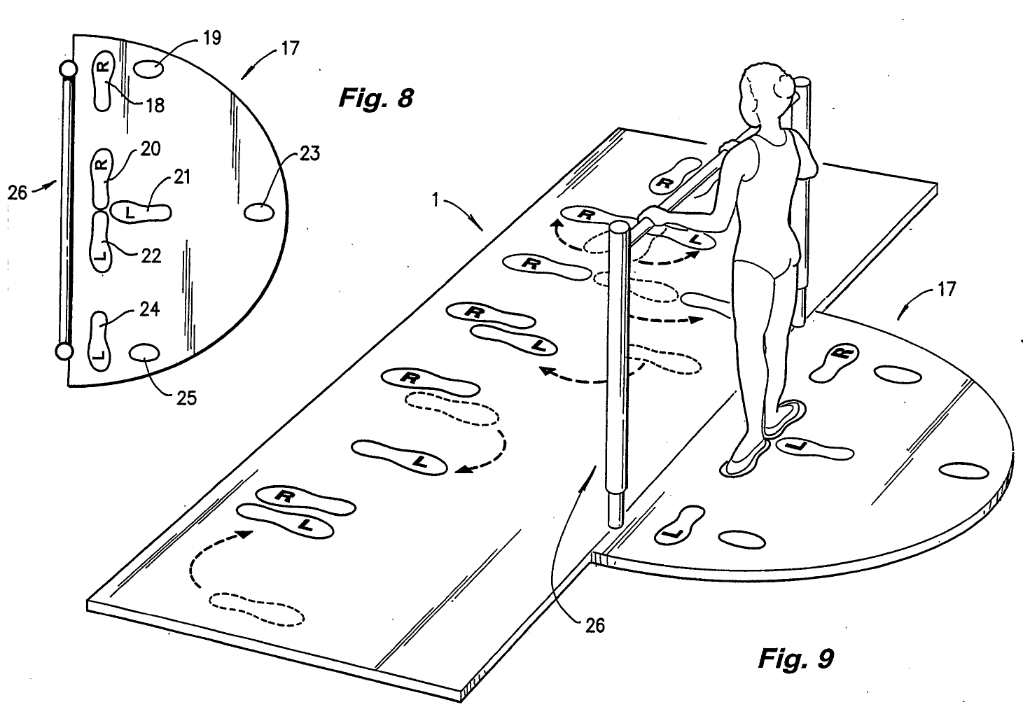

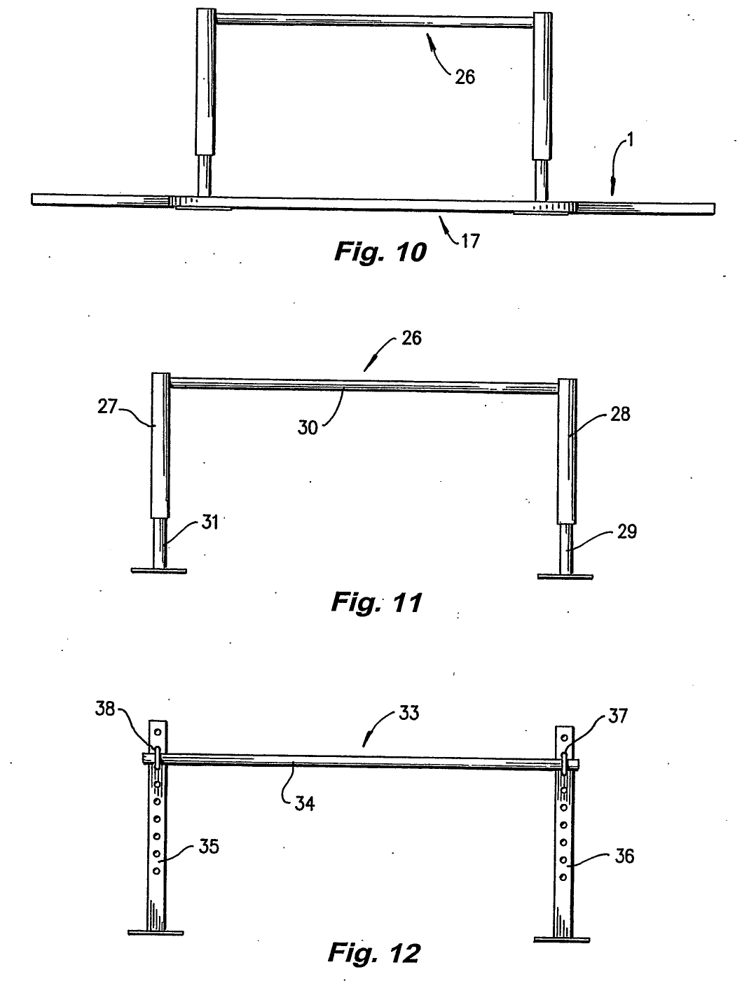

Referring now to FIG. 8, the training device of the present invention can be used with training mat 17 and ballet bar 26 alone. Alternatively, training mat 17 can be used in conjunction with ballet bar 33. In still another embodiment of the present invention, training mat 17 can be used in conjunction with a wall mounted ballet bar device.

Referring now to FIG. 9, the training device of the present invention is illustrated with an individual using said device. Alternatively, the training device of the present invention can be used with two dancers simultaneously. Both individuals use the ballet bar device to support themselves.

Referring to FIG. 11, the ballet balancing bar 26 is illustrated and is constructed so that the height of bar 30 is adjustable. This is preferably accomplished with adjustable-height members in any conventional mechanical means, such as collapsing with a sliding or telescoping action. In the illustrated embodiment in FIG. 11, the collapsing action is accomplished with telescoping frame members 27 and 28. In this embodiment, the telescoping is accomplished by having lower members 29 and 31 slide within upper members 28 and 27, respectively and may be reasonably locked in a number of height positions by any conventional means as would be apparent by those skilled in the art. Alternatively, the telescoping could be accomplished by having upper members 27 and 28 slide within lower members 31 and 29, respectively and may be reasonably locked in a number of height positions by any conventional means as would be apparent by those skilled in the art.

Another embodiment of the ballet bar device is illustrated in FIG. 12, and is constructed so that the height of ballet bar 34 is adjustable. This is preferably accomplished by having bar 34 held to substantially vertical members 35 and 36 by anchorage assemblies 38 and 37. The substantially vertical members 35 and 36 have a number of spaced holes so that ballet bar 34 can be held at the desired height.

The ballet bar device can be accomplished with alternative frame designs as long as it carries a ballet bar of adjustable height. Alternatively, the ballet bar can be wall mounted and the training mats used separately as illustrated in FIGS. 6 and 7.

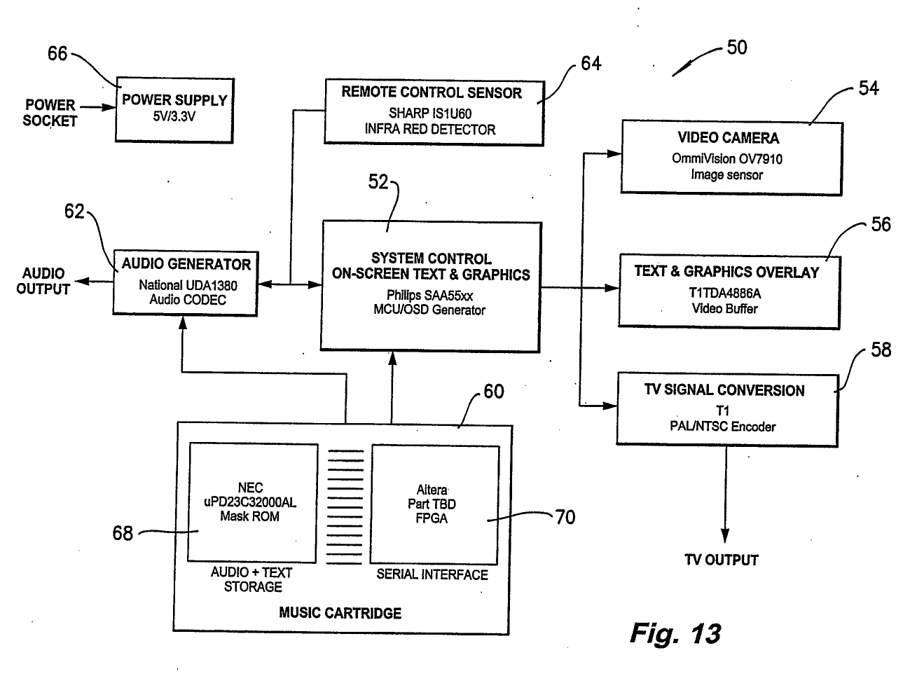

Shown in FIG. 13 is a system that enables video image capture of an individual dancer, optional recording thereof, and enabling the overlay of text and graphical images on the captured real time video image. Cartridges or cards that have prerecorded music and text or graphics data may also be used by the system and controlled by the individual dancer. The system 50 depicts a video base station unit that includes a processing means 52 in the form of a micro-controller and on screen display generator. Although these two modules are combined in the one unit they may optionally be provided as two distinct units. The processing means 52 controls all system functionality and runs software that controls all other modules in the system. It is linked to an image sensor 54, a video buffer 56, a video encoder 58, cartridge means 60, an audio generator unit 62 and receives infrared signals through an infrared detector 64 (remote control sensor). The whole system is powered by a power supply 66 which typically will be a linear type delivering to two voltage rails, one being at five volts and the other being at 3.3 volts.

The processing means 52 processes infrared commands from the remote control sensor 64, reads music data stored in a memory module 68 of the cartridge means 60, configures the video buffer 56 and the video encoder 58 and provides control signals to the image sensor 54. It also provides control signals to the audio generator 62. The electronic componentry forming the micro-controller unit and on screen display generator 52 may be a Philips SAA55xx. The on screen display generator module of the processing means 52 receives instructions from the micro-controller unit in order to generate text and graphics. The RGB video information is then fed to the video buffer 56 for multiplexing with the video signal transmitted from the image sensor 54. The text and graphical images that are multiplexed or overlayed with the image from the image sensor is also stored in the memory module 68 of the cartridge means 60.

The image sensor 54 is a CMOS system-on-a-chip solution, that provides a video signal output. A lens is mounted above the sensor and together with the sensor capture a live image of a dancer performing a dance routine or dance steps. A swivelling head may house the image sensor which allows the user or individual to easily adjust the camera angle to suit a particular application. The image sensor 54 is controlled by the micro-controller unit in processor means 52, for example to stop and start the image capture, zoom in or zoom out on the particular subject being captured. A particular version of an image sensor is produced by OmniVision model number OV7910.

The video buffer 56 primarily combines the video image which is output from the video image sensor or video camera 54 with the on screen display information that is generated by the on screen display generator in unit 52. Implementation of the video buffer is by Texas Instruments having the code IDA4886A.

The video encoder 58 converts the RGB video signal received from the video buffer 56 into a format acceptable to a consumer television or video recorder, such as NTSC or PAL. The video encoder 58 converts the video signal to either standard depending on its configuration. The audio generator 62 is in a form of an audio codec developed by National and under the model number UDA1380. It converts the digital stream of music data from the memory module 68 into an audio signal as an audio output. In addition it has a built in compression system that allows the digital music data to be stored more efficiently. The data is read from the music cartridge 60 and passed to the audio generator 62 by the micro-controller in unit 52.

The cartridge means 60 in the form of a music cartridge stores audio data and on screen text or graphic information in the memory module 68. It is otherwise known as a “personality card” which stores music and text information as a memory storage device. Each card or cartridge can be expected to store up to five songs however more songs may be stored. The text information or graphical images typically may pertain to steps of a particular dance routine. The cartridge can be replaced by the user allowing music and dance programs generated by the system to be changed. The memory module 68 is typically a Mask ROM made, for example, by NEC under model name uPD23C32000AL. It is able to store a large amount of data and because the cartridge is removable all connections between the cartridge and the base station unit must pass through a connector 70. In order to keep the number of connections to a minimum, data is transferred serially, and all address clocking is generated on board the cartridge 60. The particular connector is a serial interface field programmable gate array (FPGA) which for example may be manufactured by Altera. The audio or music that is output from the audio generator 62 is delivered either to the television, for play back and viewing, and optionally to a video cassette recorder for recordal on to tape for later use by the individual.

The remote control sensor or infrared detector 64 receives signals from a remote control unit activated or controlled by the individual or dancer and transfers those signals to the micro-controller unit in processing means 52 for further processing. The remote control sensor may be an off the shelf modulated infrared television remote sensor such as one that is developed by Sharp under model number IS1U60.

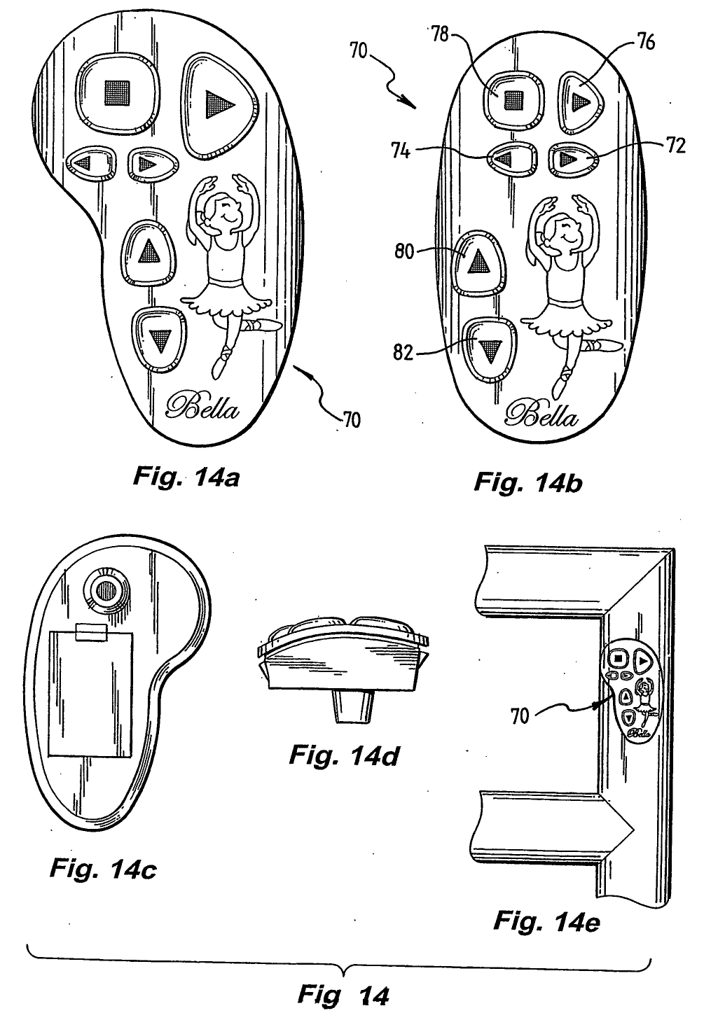

On the dance bar there may be incorporated a key pad 71 which is controlled by the individual or user and having a transmitter that transmits the signals to the remote control sensor unit 64. A typical example is shown in FIG. 14 whereby the key pad 71 has a six button function such as one button each for activating the next song which is stored in the memory module 68 of the music cartridge (button 72), a button 74 to activate the previous song, another button 76 to start playing the song, a further button 78 to stop the playing of a song. Two extra buttons 80, 82 may be used to control the volume either up or down of the audio output. The remote control unit will require power in the form of portable batteries such as AAA batteries. The transmitter in the remote control unit may be a standard infrared device, such as a light emitting diode, that converts the electrical signals into an infrared signal for transmission of the various commands by the individual to the base station unit and more particularly to be received by the remote control sensor 64. The micro-controller unit then processes the signals from the remote control sensor to determine which button has been pressed on the remote control unit by the user in order to activate the appropriate command such as alternating a song or changing the volume.

The system may be configured to train hearing-impaired individuals by providing signs or other indicators in the text and/or graphical images produced in the video signal displayed to the individual in order to assist their understanding of dance routines or movements. There may also be images of an instructor performing the dance training for the individual to follow.

Thus in use the dancer will have access to a dance bar that has the remote control unit 71 incorporated therein and be positioned in front of the image sensor or video camera 54 to enable real time recording and image display available to the individual or dancer. Initiation of image capture by the image sensor 54 may be conducted by either the individual or dancer or another operator remote from the individual. The image sensor 54 is initiated to capture the image of the dancer on instructions from the micro-controller in unit 52. Thus if activation of the image sensor is incorporated in the remote control unit, once the individual depresses the nominated button to activate the image sensor the particular signals are transmitted by infrared to the remote control sensor 54 which is then picked up by the micro-controller to thereby initiate capture of the image by the image sensor 54. As the individual or dancer is undertaking the dance instruction, with reference to the image of themselves on a television screen, the unit 52 generates text or graphical images to be overlayed or multiplexed with the television signal so that the individual will see themselves performing the routine in conjunction with text or graphical images displayed on the television display unit. The text assists the individual to perform particular dance routines or particular instructions. As mentioned previously, the text and graphical images are stored in memory module 68 and recalled or read by the unit 52. The individual may insert a music cartridge 68 storing a number of songs to dance to and through the remote control unit may control the playing of those songs which are output by the unit 62 in conjunction with the video signal. The image and audio may be recorded by a separate video cassette recorder so that the individual may view themselves or use the tape recording in their own time.

The overall unit 50 will usually rest on top of the television display and the individual may use a set of plastic dance bars facing the television display when practising their dance moves.

Accordingly, the present invention allows individuals wishing to learn ballet, a practical device that will help them acquire the skills and confidence in the basic ballet steps. Knowledge of the basic ballet steps is fundamental for the future development of the dancer. The present invention avails itself of the advantage that the dancer can practice the basic ballet movements while supporting themselves with the provided ballet balancing bar. This allows the dancer to acquire the necessary skills to progress at an accelerated rate compared to dancers who do not practice. Additionally, the use of tactile indicia as herein before defined will help visually impaired dancers learn to dance. The use of an electronic training system enables the individual to perform a dance routine or train, using text or graphics information, displayed in conjunction with an image of themselves, in their own time whenever they wish.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The present invention relates generally to training devices to teach proper foot position and movement for individuals, especially novice ballet dancers, wherein the training device comprises a training mat and an adjustable height ballet bar. The correct position of the bar is a function of the height of the user and it is important to be able to adjust the height of the bar, especially for young individuals. It is believed that the training device avails itself of the advantage of helping individuals to learn the basic ballet steps. Additionally, it is thought that the use of the training device as herein defined will help visually impaired students acquire a level of proficiency in the basic ballet steps.

1. A training device for a dancer comprising a mat or the like wherein said mat is provided with a set of indicia representing the preferred position for the dancer during any one or a combination of movements pertaining to said dance.

2. A device according to claim 1 wherein said indicia represent the position of the feet and/or the toe region of said dancer.

3. A device according to claim 2 wherein said indicia represent a sequential combination of movements pertaining to said dance.

4. A device according to claim 3 wherein said indicia represent a sequential and progressive series of movements pertaining to said dance.

5. A device according to claim 3 wherein said indicia represent a sequential and reversible series of movements pertaining to said dance.

6. A device according to claim 1 wherein said indicia are positioned to indicate the preferred foot position for a dancer with short legs.

7. A device according to claim 1 wherein said mat is provided with indicia dedicated to a selection of movements pertaining to said dance.

8. A device according to claim 7 wherein said selection is the left leg movement of said dance.

9. A device according to claim 7 where said selection is the right leg movement of said dance.

10. A device according to claim 7 a wherein said mat has a selection of indicia applied to alternate sides of said mat.

11. A device according to claim 10 wherein said indicia selection are chosen from a matching set of indicia including left and right matching indicia.

12. A device according to claim 1 comprising a plurality of said mats or the like wherein each mat is provided with indicia dedicated to a selection of movements pertaining to said dance.

13. A device according to claim 12 wherein said plurality of mats operate in combination.

14. A device according to claim 12 wherein said plurality of mats are adapted to provide indicia to represent both progressive and reversible movements when said plurality of mats operate in combination.

15. A device according to claim 1 wherein said indicia are visual means applied to said mat.

16. A device according to claim 15 wherein said visual means are foot and/or toe facsimiles printed on said mat.

17. A device according to claim 15 wherein said visual means are color coded.

18. A device according to claim 1 wherein said indicia are tactile means applied to said mat.

19. A device according to claim 18 wherein said tactile means are foot and/or toe facsimiles applied or embossed on said mat.

20. A device according to claim 1 further including a balancing device comprising horizontal and/or vertical bars adapted for positioning at or near said mat or mats to assist the dancer in balancing during the performance of said dance movements.

21. A device according to claim 20 wherein said balancing device is vertically and horizontally adjustable.

22. A device according to claim 16 wherein said mat is adapted for co-engagement with a second or subsequent mat so as to provide a means of assembling an array of mats to provide a plurality of mats or the like wherein each mat is provided with indicia dedicated to a selection of movements pertaining to said dance.

23. A device according to claim 22 wherein said co-engagement is provided by protruding and co-engageable lugs formed at the edge of said mat.

24. A device according to claim 22 wherein said co-engagement is provided by a zipper.

25. A device according to claim 1 wherein said indicia represent the preferred positions for a ballet dancer.

26. An electronic system for training a dancer comprising:
i) video capture means for capturing a live image of the dancer as the dancer performs a dance routine;
ii) means for generating text and/or graphical images for display to the dancer in conjunction with the live image; and
iii) display means for displaying the live image combined with the text and/or graphical images to the dancer to aid the dancer to perform the dance routine.

27. A system according to claim 26 wherein said dancer has a mat provided with a set of indicia representing preferred positions for the dancer during a dance routine, the system

28. A system according to claim 26 further comprising video buffer means for combining the live image of the dancer with the text and/or graphical images as a combined signal.

29. A system according to claim 28 further comprising video encoding means for receiving the combined signal from the video buffer means.

30. A system according to claim 29 wherein the display means is a television terminal linked to an output of the video encoding means so as to receive the combined signal.

31. A system according to claim 28 further comprising a portable cartridge means having a memory module.

32. A system according to claim 31 wherein the memory module stores any one of music, audio, text and/or graphical images in digital form for use by the system.

33. A system according to claim 32 wherein the cartridge means is linked to an audio generator for generating audio corresponding to the stored music or audio.

34. A system according to claim 33 wherein the generated audio is broadcast with the combined signal.

35. A system according to claim 34 further comprising a remote control unit operable by the dancer that is used to control the playing of the audio or music from the cartridge means and to control the operation of the video capture means.

36. A system according to claim 35 wherein the video capture means is an image sensor.

37. A system according to claim 35 wherein the video capture means is a video camera.

38. A system according to claim 35 wherein the remote control unit is housed in balancing bars used by the dancer to assist in providing support or balance as the dancer performs the dance routine.

39. A system according to claim 38 further comprising processing means for controlling the audio generator, reading and writing to the cartridge means, controlling the video buffer means, video encoder means and video capture means.

40. A system according to claim 39 wherein the processing means is linked to an infrared detector or remote control sensor for receiving infrared signals from the remote control unit.

41. A system according to claim 26 wherein the means for generating text and/or graphical images is produced by an on-screen display generator.

42. A system according to claim 26 wherein the live image and/or overlayed text and/or graphical images is recorded on recording means linked to the television terminal for use by the dancer.

43. A system according to claim 26 wherein any generated text or graphical images pertain to steps of the dance routine.

44. An electronic method for training a dancer comprising the steps of:
i) capturing a live image of the dancer as the dancer performs a dance routine;
ii) generating text and/or graphical images;
iii) overlaying or combining the granted text and/or graphical images with the live image; and
iv) displaying to the dancer the combined live image and text and/or graphical images to aid the dancer to perform the dance routine.

45. An electronic method according to claim 44 further comprising the step of storing any one of music, audio, text and/or graphical images in digital form on a portable cartridge means.

46. An electronic method according to claim 45 further comprising the step of generating audio or music to be combined and broadcast with the live image and text and/or graphical images.

47. An electronic method according to claim 44 further comprising the step of recording the combined live image and text and/or graphical images.

48-50. (canceled)
